(19) United States
(12) Patent Application Publication
(10) Pub. No.: US 2018/0367244 A1
(43) Pub. Date: Dec. 20, 2018

(54) Method And Apparatus For Uplink Partial Sub-Frame Transmission In Mobile Communications

(71) Applicant: MediaTek Inc., Hsinchu City (TW)

(72) Inventors: Weidong Yang, San Diego, CA (US); Bo-Si Chen, Hsinchu City (TW)

(21) Appl. No.: 16/009,504

(22) Filed: Jun. 15, 2018

Related U.S. Application Data
(60) Provisional application No. 62/521,134, filed on Jun. 16, 2017.

(51) Int. Cl. H04L 1/00; H04L 1/18; H04L 5/00

(52) U.S. Cl. CPC H04L 1/0041; H04L 5/0053; H04L 1/1861; H04L 1/0068

(57) ABSTRACT

Various solutions for uplink partial sub-frame transmission with respect to user equipment and network apparatus in mobile communications are described. An apparatus may map a plurality of code blocks to radio resources by a frequency-first manner. The apparatus may determine an uplink transmission starting point. The apparatus may puncture the code blocks before the uplink transmission starting point. The apparatus may transmit at least one complete code block after the uplink transmission starting point.

### CROSS REFERENCE TO RELATED PATENT APPLICATION(S)

The present disclosure is part of a non-provisional application claiming the priority benefit of U.S. patent application Ser. No. 62/521,134, filed on 16 Jun. 2017, the content of which is incorporated by reference in its entirety.

### TECHNICAL FIELD

The present disclosure is generally related to mobile communications and, more particularly, to uplink partial sub-frame transmission with respect to user equipment and network apparatus in mobile communications.

### BACKGROUND

Unless otherwise indicated herein, approaches described in this section are not prior art to the claims listed below and are not admitted as prior art by inclusion in this section.

In a newly developed communication system, unlicensed band transmission is introduced to facilitate data transmission or enhance data throughput. The data transmission may be transmitted among nodes of the communication system in the unlicensed frequency band. The unlicensed band transmission may not be well configured or coordinated and may cause significant interferences to neighboring nodes. Thus, proper interference management mechanisms may also be needed to mitigate/avoid the interferences. The transmitting node may be configured to perform an interference estimation before transmitting data. After the interference estimation, the transmitting node may determine whether to transmit data according to the estimation result. Accordingly, an additional or flexible uplink transmission starting point is introduced for the transmitting node to adaptively determine a proper starting point for transmitting data. The uplink transmission starting point may be determined by the transmitting node or configured by the network side.

A user equipment (UE) may be configured to perform a listen-before-talk (LBT) estimation to measure the interference before transmitting the uplink data. The UE may be able to determine the uplink transmission starting point according to the outcome of the LBT estimation. The UE may determine the uplink transmission starting point at middle of a sub-frame. Accordingly, the UE may transmit a partial sub-frame for the uplink transmission. However, the UE may be configured to determine the transport block size (TBS) for the full sub-frame regardless of the uplink transmission starting point. The uplink data may be distributed over the whole sub-frame. Therefore, how to map or allocate the data of the transport block to the sub-frame may become important and may affect the transmission efficiency. Accordingly, it is needed to provide a proper mapping mechanism for uplink transmission when only partial sub-frame may be transmitted.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issues pertaining to uplink partial sub-frame transmission with respect to user equipment and network apparatus in mobile communications.

In one aspect, a method may involve an apparatus mapping a plurality of code blocks to radio resources by a frequency-first manner. The method may also involve the apparatus determining an uplink transmission starting point. The method may further involve the apparatus puncturing the code blocks before the uplink transmission starting point. The method may further involve the apparatus transmitting at least one complete code block after the uplink transmission starting point.

In one aspect, an apparatus may comprise a transceiver capable of wirelessly communicating with a plurality of nodes of a wireless network. The apparatus may also comprise a processor communicatively coupled to the transceiver. The processor may be capable of mapping a plurality of code blocks to radio resources by a frequency-first manner. The processor may also be capable of determining an uplink transmission starting point. The processor may further be capable of puncturing the code blocks before the uplink transmission starting point. The processor may further be capable of transmitting at least one complete code block after the uplink transmission starting point.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario under schemes in accordance with implementations of the present disclosure.

FIG. 2 is a diagram depicting an example scenario under schemes in accordance with implementations of the present disclosure.

FIG. 3 is a block diagram of an example communication apparatus and an example network apparatus in accordance with an implementation of the present disclosure.

FIG. 4 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to uplink partial sub-frame transmission with respect to user equipment and network apparatus in mobile communications. According to the present disclosure, a number of possible solutions may be implemented separately or jointly. That is, although these possible solutions may be described below separately, two or more of these possible solutions may be implemented in one combination or another.

In LTE, NR or a newly developed communication system, unlicensed band transmission is introduced to facilitate data transmission or enhance data throughput. The data transmission may be transmitted among nodes (e.g., UE and/or network apparatus) in the unlicensed frequency band. The unlicensed band transmission may not be well configured or coordinated and may cause significant interferences to neighboring nodes. Thus, proper interference management mechanisms may also be needed to mitigate/avoid the interferences. The transmitting node may be configured to perform an interference estimation before transmitting data. After the interference estimation, the transmitting node may determine whether to transmit data according to the estimation result. Accordingly, an additional or flexible uplink transmission starting point is introduced for the transmitting node to adaptively determine a proper starting point for transmitting data. The uplink transmission starting point may be determined by the transmitting node or configured by the network side.

Specifically, the UE may be configured to perform an LBT estimation to measure the interference before transmitting the uplink data. The UE may be able to determine the uplink transmission starting point according to the outcome of the LBT estimation. The UE may determine the uplink transmission starting point at an orthogonal frequency-division multiplexing (OFDM) symbol within a sub-frame. For example, the uplink transmission starting point may be determined at symbol #0, symbol #1, symbol #7 or middle of a symbol. Accordingly, the UE may transmit a partial sub-frame (e.g., from symbol #7 to symbol #13) for the uplink transmission. However, the UE may be configured to determine the TBS for the full sub-frame regardless of the uplink transmission starting point. In other words, the uplink data may be distributed over the whole sub-frame. Therefore, how to map or allocate the data of the transport block to the sub-frame may become important and may affect the transmission efficiency.

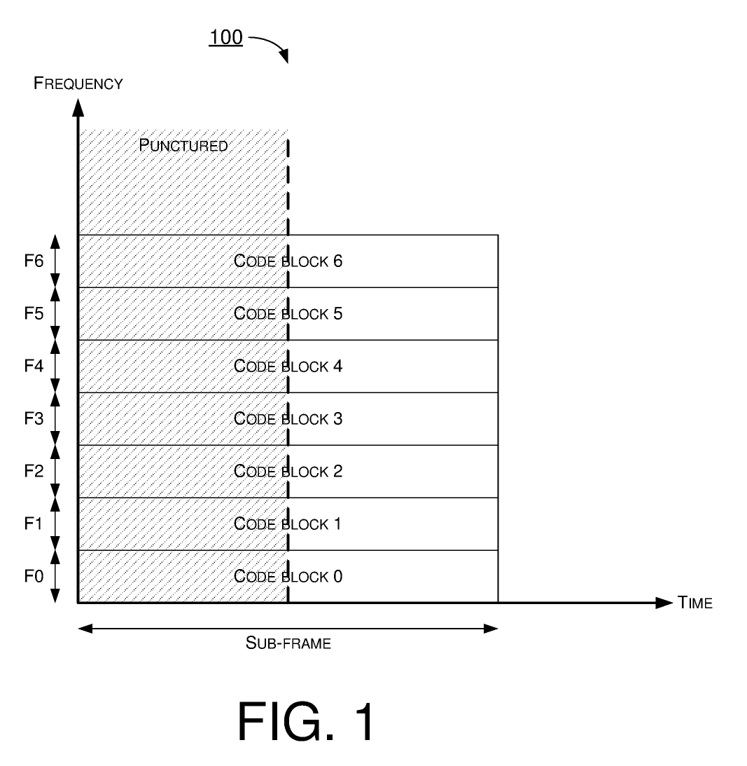

FIG. 1 illustrates an example scenario 100 under schemes in accordance with implementations of the present disclosure. Scenario 100 involves a UE and a network apparatus, which may be a part of a wireless communication network (e.g., an LTE network, an LTE-Advanced network, an LTE-Advanced Pro network, a 5G network, an NR network, an IoT network or an NB-IoT network). FIG. 1 illustrates a time-first manner for mapping the transport block onto the radio resources. Specifically, the network apparatus may be configured to configure the radio resources for the UE to perform uplink transmission. The configured radio resources may indicate a specific time-frequency region which may comprise a plurality of resource elements (REs) or physical resource blocks (PRBs). The transport block needed to be transmitted may comprise a plurality of code blocks. The UE may be configured to map the code blocks to the configured radio resources.

As showed in FIG. 1, the UE may be configured to map the plurality of code blocks onto the radio resources in time domain first. For example, the UE may distribute code block 0 over the whole sub-frame in time domain and the frequency span F0 in frequency domain. The UE may distribute code block 1 over the same whole sub-frame in time domain and the frequency span F1 in frequency domain. Similarly, the UE may distribute code blocks 2 to 6 over the same whole sub-frame in time domain and the frequency spans F2 to F6 respectively in frequency domain. Accordingly, each of the code blocks may be distributed in the same time interval and different frequency spans.

The UE may be configured to perform an interference estimation (e.g., LBT). The UE may be configured to determine an uplink transmission starting point according to the result of the interference estimation. For example, the UE may determine the uplink transmission starting point at symbol #7 of the sub-frame. The UE may be configured to puncture the code blocks before the uplink transmission starting point and transmit the code blocks after the uplink transmission starting point. In other words, the UE may only transmit part of code blocks in a partial sub-frame. In this implementation, all the code blocks may be affected by the puncturing since each code block is distributed over the whole sub-frame. A part of data (e.g., first half) of each code block may be punctured and may not be transmitted. Accordingly, since each code block may not be fully transmitted, the network apparatus may have difficulty to decode the transmitted code blocks. The puncturing may rise the code rate of each code block and may increase the decoding failure rate of each code block. The network apparatus may then indicate re-transmission for all of the code blocks. The transmission efficiency may be degraded due to the high decoding failure rate and the great amount re-transmissions.

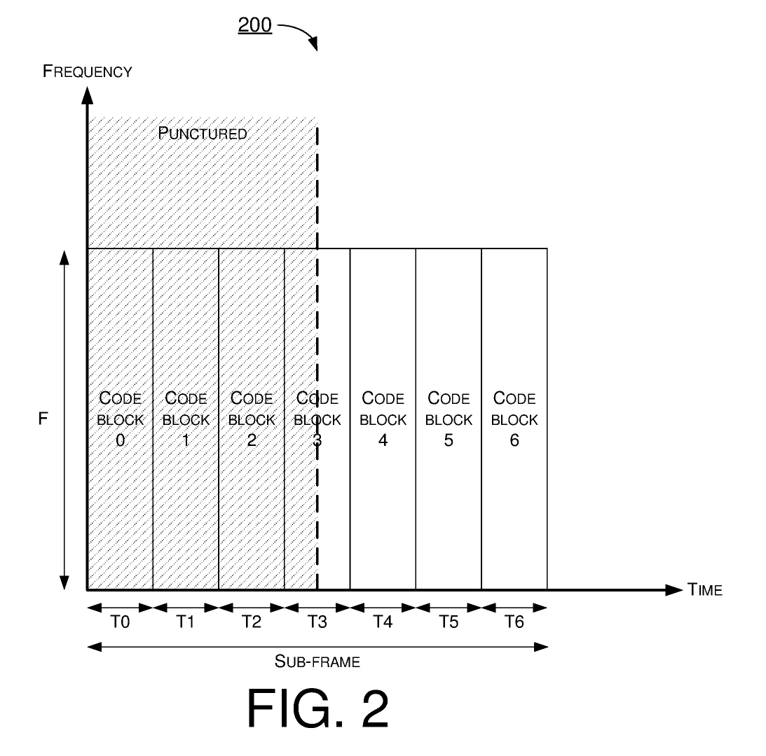

FIG. 2 illustrates an example scenario 200 under schemes in accordance with implementations of the present disclosure. Scenario 200 involves a UE and a network apparatus, which may be a part of a wireless communication network (e.g., an LTE network, an LTE-Advanced network, an LTE-Advanced Pro network, a 5G network, an NR network, an IoT network or an NB-IoT network). FIG. 2 illustrates a frequency-first manner for mapping the

transport block onto the radio resources. Similarly, the network apparatus may be configured to configure the radio resources for the UE to perform uplink transmission. The configured radio resources may indicate a specific time-frequency region which may comprise a plurality of REs or PRBs. The transport block needed to be transmitted may comprise a plurality of code blocks. The UE may be configured to map the code blocks to the configured radio resources.

As showed in FIG. 2, the UE may be configured to map the plurality of code blocks onto the radio resources in frequency domain first. For example, the UE may distribute code block 0 over the whole frequency span F in frequency domain and the time interval T0 in time domain. The UE may distribute code block 1 over the same frequency span F in frequency domain and the time interval T1 in time domain. Similarly, the UE may distribute code blocks 2 to 6 over the same frequency span F in frequency domain and the time intervals T2 to T6 respectively in time domain. Accordingly, each of the code blocks may be distributed in the same frequency span and different frequency time intervals.

The UE may be configured to perform an interference estimation (e.g., LBT). The UE may be configured to determine an uplink transmission starting point according to the result of the interference estimation. For example, the UE may determine the uplink transmission starting point at symbol #7 of the sub-frame. The UE may be configured to puncture the code blocks before the uplink transmission starting point and transmit the code blocks after the uplink transmission starting point. In other words, the UE may only transmit part of code blocks in a partial sub-frame. In this implementation, only some of the code blocks may be affected by the puncturing since the code blocks are

mapped to the radio resources by a frequency-first manner. For example, when the puncturing happens, only code blocks 0 to 3 are impacted. Code blocks 4 to 6 may still have high probability to be successfully transmitted and decoded. Code blocks 0 to 2 and part of code block 3 are punctured and may not be transmitted. The network apparatus may only indicate re-transmission for code blocks 0 to 3. Since at least one complete code block (e.g., code blocks 4-6) is transmitted, the UE may not need to re-transmit all the code blocks. Accordingly, since only part of all code blocks may be punctured and may need re-transmission, the transmission efficiency may be increased.

Due to that some of the code blocks may not fully transmitted, the network apparatus may not be able to successfully decode all the code blocks and may request re-transmission. In some implementations, the network apparatus may request the UE to re-transmit the whole transport block (i.e., all the code blocks) because not all the code blocks are successfully decoded. However, such implementation may degrade the transmission efficiency since not every code block is missed or failed. There still some code blocks are fully transmitted and may be successfully decoded by the network apparatus. Accordingly, the network apparatus may be configured to only request re-transmission for the punctured code blocks.

The network apparatus or the UE may classify the code blocks into code block groups (CBGs). The network apparatus may indicate re-transmission based on the CBG. For example, the network apparatus or the UE may determine 3 CBGs (e.g., CBG 0 to 2). CBG 0 may comprise code blocks 0 and 1. CBG 1 may comprise code blocks 2 and 3. CBG 2 may comprise code blocks 4, 5 and 6. The UE may be configured to receive an indication corresponding to the CBGs for indicating whether re-transmission is needed or not. For example, the UE may receive a bitmap (1, 1, 0) corresponding to CBG 0 to 2 from the network apparatus. The UE may be configured to determine whether to re-transmit the CBG according to the indication. The first bit 1 of the bitmap may represent that the UE should re-transmit CBG 0 (i.e., code blocks 0 and 1). The second bit 1 of the bitmap may represent that the UE should re-transmit CBG 1 (i.e., code blocks 2 and 3). The third bit 0 of the bitmap may represent that the UE does not need to re-transmit CBG 2 (i.e., code blocks 4, 5 and 6). Accordingly, less information bits (e.g., 3 bits) may be used to indicate a plurality of code blocks (e.g., 7 code blocks) by CBG based indication.

Alternatively, the network apparatus may be configured to indicate an identity (ID) of the last un-decodable code block. Specifically, the UE may be configured to receive an indication after transmitting the partial sub-frame. The indication may comprise the ID indicating the last un-decodable code block. The UE may be configured to determine which code blocks may need to be re-transmit. For example, in a case that code blocks 4 to 6 are decodable, the ID may indicate code block 3. The UE may be able to determine that code block 3 is the last un-decodable code block and may re-transmit code blocks 0 to 3. In another example, in a case that code blocks 4 and 6 are decodable but code block 5 is un-decodable, the ID may indicate code block 5. The UE may be configured to re-transmit from code block 0 to the last un-decodable code block (e.g., code blocks 0 to 5). Accordingly, the network apparatus may only indicate the last un-decodable code block. The UE may re-transmit the code blocks before the indicated code block and the indicated code block.

Alternatively, the network apparatus may be configured to transmit a single bit to indicate whether all the transmitted code blocks or all the un-punctured code blocks are decodable. Specifically, the UE may be configured to receive a single bit after transmitting the partial sub-frame. The single bit may indicate whether all the transmitted code blocks or all the un-punctured code blocks are decodable. The UE may be configured to determine whether to re-transmit a whole transport block or the punctured code blocks according to the single bit. For example, code blocks 0 to 2 may be fully punctured. Code block 3 may be partially punctured. Code blocks 4 to 6 may be the un-punctured code blocks. The single bit may indicate whether code blocks 4 to 6 are all successfully decoded or not. After receiving the single bit, the UE may determine whether it need to re-transmit the un-punctured code blocks (e.g., code blocks 4 to 6). Since the UE knows which code blocks are punctured or partially punctured (e.g., code blocks 0 to 3), the UE may be able to determine whether it need to re-transmit the whole transport block (e.g., code blocks 0 to 6) or simply the punctured code blocks (e.g., code blocks 0 to 3) according to the single bit. In a case that the single bit indicates that all the un-punctured code blocks are decodable, the UE may only need to re-transmit the punctured code blocks. In a case that the single bit indicates that all the un-punctured code blocks are un-decodable, the UE may need to re-transmit the punctured code blocks and the un-punctured code blocks. Accordingly, the network apparatus may use only single bit to indicate whether all the un-punctured code blocks are decodable. The UE may re-transmit the whole transport block or the punctured code blocks according to the single bit.

Alternatively, the network apparatus may be configured to transmit a code block based indication to indicate re-transmission for a code block. Specifically, the UE may be configured to receive an indication after transmitting the partial sub-frame. The indication may correspond to the transmitted code blocks. The UE may be configured to determine whether to re-transmit the transmitted code blocks according to the indication. For example, the indication corresponding to code blocks 3 to 6 may be enough since both the network apparatus and the UE may know that code blocks 0 to 2 are not transmitted. The indication may comprise a plurality of bits (e.g., 4 bits) to indicate the decoding results of the transmitted code blocks (e.g., code blocks 4 to 6). Each bit of the indication may correspond to each transmitted code block. For example, an indication of [0, 1, 1, 1] may be used to indicate the decoding results of code blocks 3 to 6. The bit “0” may stand for failed decoding and the bit “1” may stand for successful decoding. Therefore, the UE may be configured to re-transmit code block 3 after receiving the indication.

In some implementations, the signaling overhead of the indication may further be reduced. Specifically, for code blocks 3 to 6, the decoding results of [0, 1, 1, 1], [1, 0, 1, 1], [1, 1, 0, 1] and [1, 1, 1, 0] may be the most likely error cases since only one code block is un-decodable. The error cases such as [0, 0, 1, 1], [0, 1, 0, 1], [0, 1, 1, 0], [1, 0, 0, 1], [1, 0, 1, 0], [1, 1, 0, 0] , [0, 0, 0, 1], [0, 0, 1, 0], [0, 1, 0, 0] , [1, 0, 0, 0] and [0, 0, 0, 0] may be aggregated into one code stat “Y”. The code state “Y” may represent the severe error case since at least two code blocks are un-decodable. When the UE receives the code state “Y”, the UE may be configured to re-transmit all the transmitted code blocks (e.g., code blocks 3 to 6). Then in total, the network apparatus may indicate a combination of the decoding result corresponding to one of {[1, 1, 1, 1], [0, 1, 1, 1], [1, 0, 1, 1], [1, 1, 0, 1], [1, 1, 1, 0] and Y} to the UE. The number of the combinations may be limited to 6. Therefore, only 3 bits may be needed to indicate the re-transmission for 4 code blocks. Accordingly, the network apparatus may transmit an indication to indicate a combination of a decoding result of each transmitted code block. The indication may comprise a number of bits less than a number of the transmitted code blocks. The UE may determine which code block may need to be re-transmitted according to the indication.

### Illustrative Implementations

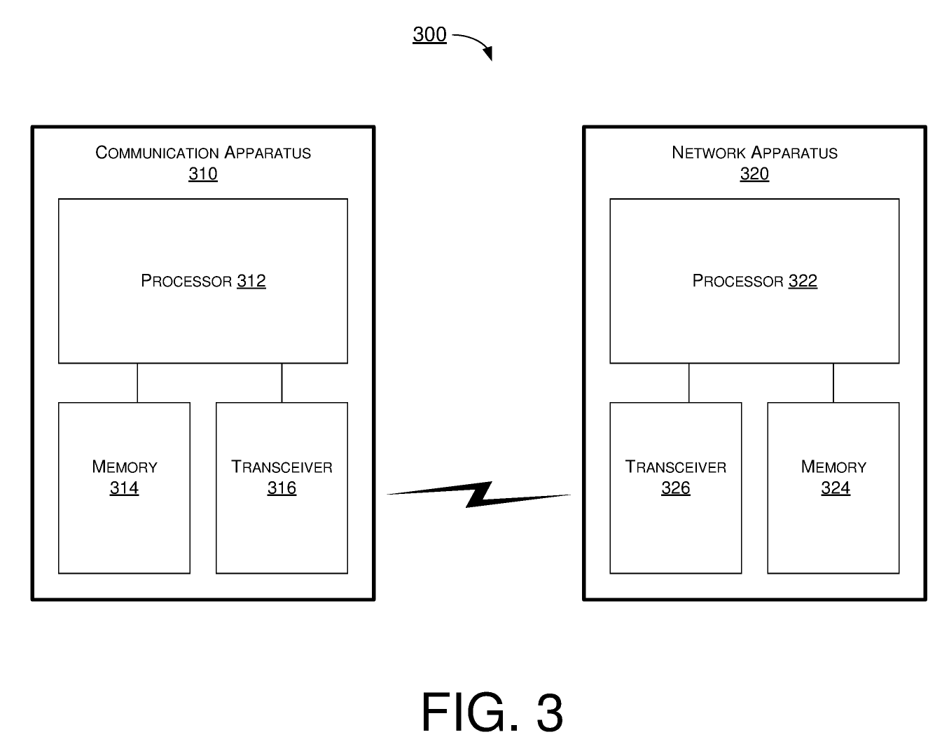

FIG. 3 illustrates an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to uplink partial sub-frame transmission with respect to user equipment and network apparatus in wireless communications, including scenarios 100 and 200 described above as well as process 400 described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT or NB-IoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, or one or more complex-instruction-set-computing (CISC) processors. Communication apparatus 310 may include at least some of those components shown in FIG. 3 such as a processor 312, for example. communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus, which may be a network node such as a base station, a small cell, a router or a gateway. For instance, network apparatus 320 may be implemented in an eNodeB in an LTE, LTE-Advanced or LTE-Advanced Pro network or in a gNB in a 5G, NR, IoT or NB-IoT network. Alternatively, network apparatus 320 may be implemented in the form of one or more IC chips such as, for example and without limitation, one or more single-core processors, one or more multi-core processors, or one or more CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including power consumption reduction in a device (e.g., as represented by communication apparatus 310) and a network (e.g., as represented by network apparatus 320) in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

In some implementations, processor 322 may be configured to configure the radio resources for communication apparatus 310 to perform uplink transmission. Processor 322 may indicate a specific time-frequency region which may comprise a plurality of REs or PRBs. Processor 312 may be configured to map a plurality of code blocks to the configured radio resources.

In some implementations, processor 312 may be configured to map the plurality of code blocks onto the radio resources in frequency domain first. For example, processor 312 may distribute a first code block over a whole frequency span F in frequency domain and a first time interval in time domain. Processor 312 may distribute a second code block over the same frequency span F in frequency domain and a second time interval in time domain. Similarly, processor 312 may distribute a third code block to a seventh code block over the same frequency span F in frequency domain and a third time intervals to a seventh time intervals respectively in time domain. Accordingly, processor 312 may distribute each of the code blocks in the same frequency span and different frequency time intervals.

In some implementations, processor 312 may be configured to perform an interference estimation (e.g., LBT). Processor 312 may be configured to determine an uplink transmission starting point according to the result of the interference estimation. For example, processor 312 may determine the uplink transmission starting point at symbol #7 of the sub-frame. Processor 312 may be configured to puncture the code blocks before the uplink transmission starting point and transmit the code blocks after the uplink transmission starting point. In other words, processor 312 may only transmit part of code blocks in a partial sub-frame. Only some of the code blocks may be affected by the puncturing since processor 312 maps the code blocks to the radio resources by a frequency-first manner. For example, processor 312 may only puncture the first to the third code blocks. Processor 312 may still transmit the fourth to the seventh code blocks. Processor 312 may puncture the first to the third code blocks and part of the fourth code block and may not transmit the punctured parts. Processor 322 may only indicate re-transmission for the first to the fourth code blocks. Since at least one complete code block (e.g., the fifth to seventh code blocks) is transmitted, processor 312 may not need to re-transmit all the code blocks. Accordingly, since only part of all code blocks may be punctured and may need re-transmission by communication apparatus 310, the transmission efficiency may be increased.

In some implementations, network apparatus 320 or communication apparatus 310 may classify the code blocks into CBGs. Processor 322 may indicate re-transmission based on the CBG. For example, processor 322 or processor 312 may determine 3 CBGs (e.g., CBG 0 to 2). CBG 0 may comprise the first and the second code blocks. CBG 1 may comprise the third and the fourth code blocks. CBG 2 may comprise the fifth to the seventh code blocks.

Processor 312 may be configured to receive, via transceiver 316, an indication corresponding to the CBGs for indicating whether re-transmission is needed or not. For example, processor 312 may receive a bitmap (1, 1, 0) corresponding to CBG 0 to 2 from network apparatus 320. Processor 312 may be configured to determine whether to re-transmit the CBG according to the indication. The first bit 1 of the bitmap may represent that processor 312 should re-transmit CBG 0 (i.e., the first and the second code blocks). The second bit 1 of the bitmap may represent that processor 312 should re-transmit CBG 1 (i.e., the third and the fourth code blocks). The third bit 0 of the bitmap may represent that processor 312 does not need to re-transmit CBG 2 (i.e., the fifth to the seventh code blocks). Accordingly, processor 322 may use less information bits (e.g., 3 bits) to indicate a plurality of code blocks (e.g., 7 code blocks) by CBG based indication.

In some implementations, processor 322 may be configured to indicate an ID of the last un-decodable code block. Specifically, processor 312 may be configured to receive an indication after transmitting the partial sub-frame. The indication may comprise the ID indicating the last un-decodable code block. Processor 312 may be configured to determine which code blocks may need to be re-transmit. For example, in a case that the fifth and the seventh code blocks are decodable, the ID may indicate the fourth code block. Processor 312 may be able to determine that the fourth code block is the last un-decodable code block and may re-transmit the first to the fourth code blocks. In some implementations, in a case that the fifth and the seventh code blocks are decodable but the sixth code block is un-decodable, the ID may indicate the sixth code block. Processor 312 may be configured to re-transmit from the first code block to the last un-decodable code block (e.g., the first to the sixth code blocks). Accordingly, processor 322 may only indicate the last un-decodable code block. Processor 312 may re-transmit the code blocks before the indicated code block and the indicated code block.

In some implementations, processor 322 may be configured to transmit a single bit to indicate whether all the transmitted code blocks or all the un-punctured code blocks are decodable. Specifically, processor 312 may be configured to receive a single bit after transmitting the partial sub-frame. The single bit may indicate whether all the transmitted code blocks or all the un-punctured code blocks are decodable. Processor 312 may be configured to determine whether to re-transmit a whole transport block or the punctured code blocks according to the single bit. For example, processor 312 may fully puncture the first to the third code blocks. Processor 312 may puncture part of the fourth code block. Processor 312 may transmit the fifth to the seventh code blocks. Processor 322 may use the single bit to indicate whether the fifth to the seventh code blocks are all successfully decoded or not. After receiving the single bit, processor 312 may determine whether it need to re-transmit the un-punctured code blocks (e.g., the fifth to the seventh code blocks). Since processor 312 knows which code blocks are punctured or partially punctured (e.g., the first to the fourth code blocks), processor 312 may be able to determine whether it need to re-transmit the whole transport block (e.g., the first to the seventh code blocks) or simply the punctured code blocks (e.g., the first to the fourth code blocks) according to the single bit. In a case that the single bit indicates that all the un-punctured code blocks are decodable, processor 312 may only need to re-transmit the punctured code blocks. In a case that the single bit indicates that all the un-punctured code blocks are un-decodable, processor 312 may need to re-transmit the punctured code blocks and the un-punctured code blocks. Accordingly, processor 322 may use only single bit to indicate whether all the un-punctured code blocks are decodable. Processor 312 may re-transmit the whole transport block or the punctured code blocks according to the single bit.

In some implementations, processor 322 may be configured to transmit a code block based indication to indicate re-transmission for a code block. Specifically, processor 312 may be configured to receive an indication after transmitting the partial sub-frame. The indication may correspond to the transmitted code blocks. Processor 312 may be configured to determine whether to re-transmit the transmitted code blocks according to the indication. For example, the indication corresponding to the fourth to the seventh code blocks may be enough since both network apparatus 320 and communication apparatus 310 may know that the first to the third code blocks are not transmitted. The indication may comprise a plurality of bits (e.g., 4 bits) to indicate the decoding results of the transmitted code blocks (e.g., the fifth to the seventh code blocks). Each bit of the indication may correspond to each transmitted code block. For example, processor 322 may use an indication of [0, 1, 1, 1] to indicate the decoding results of the fourth to the seventh code blocks. The bit “0” may stand for failed decoding and the bit “1” may stand for successful decoding. Therefore, processor 312 may be configured to re-transmit the fourth code block after receiving the indication.

In some implementations, the signaling overhead of the indication may further be reduced. When processor 312 receives a code state “Y”, processor 312 may be configured to re-transmit all the transmitted code blocks (e.g., the fourth to the seventh code blocks). Then in total, processor 322 may indicate a combination of the decoding result corresponding to one of {[1, 1, 1, 1], [0, 1, 1, 1], [1, 0, 1, 1], [1, 1, 0, 1], [1, 1, 1, 0] and Y} to communication apparatus 310. The number of the combinations may be limited to 6. Therefore, processor 322 may only use 3 bits to indicate the re-transmission for 4 code blocks. Accordingly, processor 322 may transmit an indication to indicate a combination of a decoding result of each transmitted code block. The indication may comprise a number of bits less than a number of the transmitted code blocks. Processor 312 may determine which code block may need to be re-transmitted according to the indication.

### Illustrative Processes

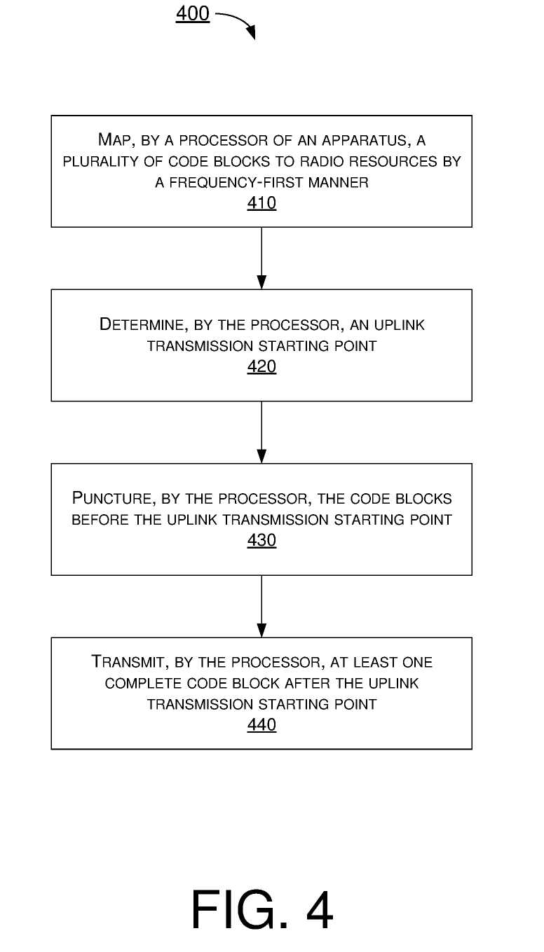

FIG. 4 illustrates an example process 400 in accordance with an implementation of the present disclosure. Process 400 may be an example implementation of scenario 200, whether partially or completely, with respect to uplink partial sub-frame transmission in accordance with the present disclosure. Process 400 may represent an aspect of implementation of features of communication apparatus 310. Process 400 may include one or more operations, actions, or functions as illustrated by one or more of blocks 410, 420, 430 and 440. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At 410, process 400 may involve processor 312 of apparatus 310 mapping, a plurality of code blocks to radio resources by a frequency-first manner. Process 400 may proceed from 410 to 420.

At 420, process 400 may involve processor 312 determining an uplink transmission starting point. Process 400 may proceed from 420 to 430.

At 430, process 400 may involve processor 312 puncturing the code blocks before the uplink transmission starting point. Process 400 may proceed from 430 to 440.

At 440, process 400 may involve processor 312 transmitting at least one complete code block after the uplink transmission starting point.

In some implementations, process 400 may involve processor 312 performing an interference estimation. Process 400 may also involve processor 312 determining the uplink transmission starting point according to a result of the interference estimation.

In some implementations, process 400 may involve processor 312 transmitting the complete code block in a partial sub-frame.

In some implementations, process 400 may involve processor 312 receiving an indication corresponding to a code block group. Process 400 may also involve processor 312 determining whether to re-transmit the code block group according to the indication. The code block group may comprise a plurality of code blocks.

In some implementations, process 400 may involve processor 312 receiving an ID indicating a last un-decodable code block. Process 400 may also involve processor 312 re-transmitting the code blocks before the indicated code block and the indicated code block.

In some implementations, process 400 may involve processor 312 receiving a single bit. Process 400 may also involve processor 312 determining whether to re-transmit a whole transport block or the punctured code blocks according to the single bit. The single bit may indicate whether all the transmitted code blocks are decodable.

In some implementations, process 400 may involve processor 312 receiving an indication corresponding to the transmitted code blocks. Process 400 may also involve processor 312 determining whether to re-transmit the transmitted code blocks according to the indication.

In some implementations, the indication may comprise a plurality of bits corresponding to each transmitted code block.

In some implementations, the indication may indicate a combination of a decoding result of each transmitted code block. The indication may comprise a number of bits less than a number of the transmitted code blocks.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations.

Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
mapping, by a processor of an apparatus, a plurality of code blocks to radio resources by a frequency-first manner;
determining, by the processor, an uplink transmission starting point;
puncturing, by the processor, the code blocks before the uplink transmission starting point; and
transmitting, by the processor, at least one complete code block after the uplink transmission starting point.

2. The method of claim 1, further comprising:
performing, by the processor, an interference estimation; and
determining, by the processor, the uplink transmission starting point according to a result of the interference estimation.

3. The method of claim 1, wherein the transmitting comprises transmitting the complete code block in a partial sub-frame.

4. The method of claim 1, further comprising:
receiving, by the processor, an indication corresponding to a code block group; and
determining, by the processor, whether to re-transmit the code block group according to the indication,
wherein the code block group comprises a plurality of code blocks.

5. The method of claim 1, further comprising:
receiving, by the processor, an identity (ID) indicating a last un-decodable code block; and
re-transmitting, by the processor, the code blocks before the indicated code block and the indicated code block.

6. The method of claim 1, further comprising:
receiving, by the processor, a single bit; and
determining, by the processor, whether to re-transmit a whole transport block (TB) or the punctured code blocks according to the single bit,
wherein the single bit indicates whether all the transmitted code blocks are decodable.

7. The method of claim 1, further comprising:
receiving, by the processor, an indication corresponding to the transmitted code blocks; and
determining, by the processor, whether to re-transmit the transmitted code blocks according to the indication.

8. The method of claim 7, wherein the indication comprises a plurality of bits corresponding to each transmitted code block.

9. The method of claim 7, wherein the indication indicates a combination of a decoding result of each transmitted code block.

10. The method of claim 7, wherein the indication comprises a number of bits less than a number of the transmitted code blocks.

11. An apparatus, comprising:
a transceiver capable of wirelessly communicating with a plurality of nodes of a wireless network; and
a processor communicatively coupled to the transceiver, the processor capable of:
mapping a plurality of code blocks to radio resources by a frequency-first manner;
determining an uplink transmission starting point;
puncturing the code blocks before the uplink transmission starting point; and
transmitting, via the transceiver, at least one complete code block after the uplink transmission starting point.

12. The apparatus of claim 11, wherein the processor is further capable of:
performing an interference estimation; and
determining the uplink transmission starting point according to a result of the interference estimation.

13. The apparatus of claim 11, wherein, in transmitting at least one complete code block, the processor is further capable of transmitting the complete code block in a partial sub-frame.

14. The apparatus of claim 11, wherein the processor is further capable of:
receiving, via the transceiver, an indication corresponding to a code block group; and
determining whether to re-transmit the code block group according to the indication,
wherein the code block group comprises a plurality of code blocks.

15. The apparatus of claim 11, wherein the processor is further capable of:
receiving, via the transceiver, an identity (ID) indicating a last un-decodable code block; and
re-transmitting, via the transceiver, the code blocks before the indicated code block and the indicated code block.

16. The apparatus of claim 11, wherein the processor is further capable of:
receiving, via the transceiver, a single bit; and
determining whether to re-transmit a whole transport block (TB) or the punctured code blocks according to the single bit,
wherein the single bit indicates whether all the transmitted code blocks are decodable.

17. The apparatus of claim 11, wherein the processor is further capable of:
receiving, via the transceiver, an indication corresponding to the transmitted code blocks; and
determining whether to re-transmit the transmitted code blocks according to the indication.

18. The apparatus of claim 17, wherein the indication comprises a plurality of bits corresponding to each transmitted code block.

19. The apparatus of claim 17, wherein the indication indicates a combination of a decoding result of each transmitted code block.

20. The apparatus of claim 17, wherein the indication comprises a number of bits less than a number of the transmitted code blocks.
